(19) United States
(12) Patent Application Publication
(10) Pub. No.: US 2006/0294595 A1
(43) Pub. Date: Dec. 28, 2006

(54) Component selector

(75) Inventor: Lior Drihem, (US)

Correspondence Address: DR. MARK FRIEDMAN LTD.;C/o Bill Polkinghorn, 9003 Florin Way, Upper Marlboro, MD, 20772, US

(73) Assignee: Check Point Software Technologies Ltd.

(21) Appl. No.: 11/166,240

(22) Filed: Jun. 27, 2005

(51) Int. Cl. H04L 9/32; H04L 9/00; G06K 9/00; G06F 17/30; G06F 7/04; G06F 15/16; H03M 1/68; G06F 7/58; H04K 1/00; G06K 19/00; H04N 7/16

(52) U.S. Cl. 726/27; 726/4; 713/176; 713/166

(57) ABSTRACT

A method for securing a server undergoing data communication with a remote client computer in a client/server network. The method includes requesting an application by a user of the remote client computer. In response to the request, the server transmits a module which runs on the remote client computer. When run, the module collects client information regarding the client computer and based on the collected client information selects one or more security mechanisms, preferably including one encryption mechanism and runs the security mechanisms on the remote client computer.

### CROSS REFERENCE TO RELATED APPLICATIONS

Not Applicable

### FIELD AND BACKGROUND OF THE INVENTION

The present invention relates to computer security and, more particularly, to a method for securing remote clients while accessing a local network. Specifically, the method includes a module which is downloaded to the client from a server attached to the local network. The module running on the client, selects installs and executes security components required to secure the remote client based on a policy of the local network.

Virtual Private Network, (VPN), is a private communications network used for secure communications over a public network. VPNs use cryptographic tunneling protocols to provide confidentiality, authentication, and message integrity. When properly selected and implemented, a virtual private network provides secure communications over otherwise insecure networks, e.g. Internet. Protocols used to establish a tunneled connections are called tunneling protocols and include PPTP (point-to-point tunneling protocol), L2TP (layer 2 tunneling protocol), IPSec (IP security, a part of IPv6), SSL (secure sockets layer).

Point-to-Point Tunneling Protocol (PPTP), developed by Microsoft, is an extension of the Internet standard Point-to-Point protocol (PPP), the link layer protocol used to transmit IP packets over serial links. PPTP establishes the tunnel but does not provide encryption.

The Layer 2 Tunneling Protocol (L2TP) developed in cooperation between Cisco and Microsoft, can be used on non-IP networks such as ATM, frame relay and X.25. Like PPTP, L2TP operates at the data link layer of the OSI networking model.

IP Security (IPSec), provides encryption for L2TP tunnels. However, IPSec can itself be used as a tunneling protocol, An IPSec VPN works only with IP-based networks and applications. Like PPTP and L2TP, IPSec requires that the VPN client computers have client software installed.

Another VPN technology is the Secure Sockets Layer (SSL) VPN. A VPN based on SSL usually uses a Web browser as the client application and therefore does not need special VPN client software previously installed on the clients.

Several methods are used for performing the encryption under SSL. One method uses link translation. If the application is a web application, then a gateway re-writes all pages sent to the client so that all links are renamed and point to the gateway using SSL. In addition, the rewritten links are extended to include the original URL. (e.g. a link to http://www.checkpoint.com is translated to:

https://gw.checkpoint.com/go-to-www-checkpoint-com)

When the application that is required is not a Web based application or when the link translation performed by the gateway is not functioning properly, then it is possible for a user with administrator privileges to install on the client what appears to the operating system as a new network interface on the client machine for instance using Active-X software. An example of a product using this method is SNX (SSL network extender) of Check Point™. (Check Point Software Technologies Ltd., Ramat Gan Israel) In reality, all information sent to or from the new “interface” is tunneled through a real physical interface to the gateway where the tunnel is opened using for example IPSEC or SSL. Another alternative is to modify the network driver or to place a new driver in series with the network driver these changes also require administrator privileges. However, it is not generally desirable to grant to users administrator privileges, e.g. permission to install a new network driver. The user may inadvertently corrupt the operating system configuration either intentionally, accidentally or as a result of an attack on the client based on content the user received e.g. by electronic mail or downloaded with a Web browser. Often, the user is not the full owner of the machine and he therefore does not have administrative permission for instance with Internet access at a public location or on a terminal server. When a user does not have permission to perform such an installation, a less demanding software running for instance with Java can be downloaded from the gateway to the client. A product using this method is SNX application connector of Check Point. Since different browsers generally run Java differently, the Java software needs to be specified according to the browser in use. The Java software launches the specific client-side application which the user requires in order to connect to the application server in his office. While performing the launch process the Java software modifies (patches) the application in such a way that all traffic is sent to a local proxy, or otherwise a proxy safe to communicate with, instead of the original requested destination. The proxy then tunnels all information to the gateway where the tunnel is restored and the true unpatched destination of the connection is also restored. For some applications, this method may not work and therefore it is preferable to check the compatibility of the application using a list of compatible applications which are identified based on the application's signature or name and version.

A well-designed VPN can greatly benefit an organization by extending geographic connectivity, improve security where data lines have not been ciphered, reduce operational costs versus traditional WAN, reduce transit time and transportation costs for remote users, improve productivity, simplify network topology in certain scenarios, provide global networking opportunities, provide telecommuter support, provide broadband networking compatibility.

However, since VPNs extend the “mother network” by such an extent (almost every employee) and with such ease (no dedicated lines to hire), there are certain security implications that have to receive special attention: Security on the client side has to be tightened and enforced. Access to the target network may have to be limited. Logging must be evaluated and in most cases revised.

VPNs, whether SSL or IPSec, are not inherently secure. While the technologies provide transport encryption, a secure VPN requires additional features to ensure the confidentiality of data passed to the client computer at the endpoint and to protect an organization from attacks that can come from the endpoint. One method used for securing the client computer is with the use of a “secure browser”. A secure brower includes additional security features such as virus and “spy-ware” detection as well as encryption of the session data.

There is thus a need for, and it would be highly advantageous to have a method which secures a server undergoing data communication with a remote client computer in a client/server network by downloading a module from the server to the client computer and run on the client computer. The module runs and selects one or more security mechanisms based on client information that is collected on the client computer.

References
http://en.wikipedia.org/wiki/Virtual_private_network
http://www.windowsecurity.com/articles/VPN-Options.html (Deb Schinder)

### SUMMARY OF THE INVENTION

The terms “executable module” and “module” are used herein interchangeably.

The term “module” as used herein includes at least in part a macro, script or otherwise executable program which runs under an application e.g. browser, or operating system in a client computer. In some embodiments of the present invention, the module include at least a portion written in extensible mark-up language.

The term processing as used herein to refer to data includes but is not limited to filtering, encrypting and/or decrypting data.

The term “security mechanism” as used herein refers to any mechanism for increasing security on a client computer. Such security mechanisms include but are not limited to virtual private networks, use of secure socket layer, encryption, secure browser, spy-ware scanner, anti-virus scanning and firewall.

The term “selecting” as used herein in the context of security mechanisms is defined as “selecting at least one security mechanism from a plurality of available security mechanisms”.

The term “client information” as used herein refers to information collected on the client computer useful for the purpose of selecting a security mechanism by the module. An approval, “Yes” for instance, to perform a virus scan is not “client information” in the context of the present invention, if the program performing the scan is already selected.

The terms “enable” and “run” when referring to a security mechanism are used interchangeably.

The terms “server” and “gateway” are used herein interchangeably.

According to the present invention there is provided a method for securing a server undergoing data communication with a remote client computer in a client/server network. The method includes requesting an application by a user of a remote client. In response to the request, the server transmits a module which runs on the remote client computer. When run, the module collects client information regarding the client computer and based on the collected client information selects one or more security mechanisms. Preferably, the client information is collected without prompting the user. Preferably the security mechanisms two or more encryption mechanisms and the selection enables solely one of the available encryption mechanisms. Preferably, the module is transmitted securely from the server to the remote client computer using a security mechanism such as secure sockets layer (SSL) and/or a digital signature. Preferably, the module identifies the user of the remote client computer. Preferably, the server selects the module appropriate for the remote client computer based on client information received from the remote client computer. Preferably, the module is written in a language such as Java or ActiveX the selection of the language dependent on a browser running on the client computer. Preferably, the module selects a security mechanism based on criteria such as: (i) client applications installed on the remote client computer, (ii) preferences of a user running the remote client computer, (iii) privileges of a user running the remote client computer and (iv) connectivity tests between the remote client computer and the server. Preferably, the module selects the security mechanism based on one or more applications installed on the client computer such as an operating system and a Web browser. Preferably, the selection of one or more security mechanisms is based on an identity of a user of the client computer and/or operating system privileges of the user and/or a Web browser type and/or Web browser version number running on the client computer. Preferably, the selection of one or more security mechanisms is based on a signature of one or more applications being used on the client computer. When the information collected on the client computer indicates a conflict between an application running on the client computer and a security mechanism, the selection of the security mechanism is performed to resolve the conflict. The method further includes running the security mechanisms on the client computer. Preferably, an available security mechanism is a virtual private network (VPN) based on a secure sockets layer. Preferably, one of the security mechanisms includes the implementation of one virtual private network selected from: (i) an emulation of a network interface on the client; (ii) a modification of an existing network interface; (iii) processing traffic passing between a network interface and an operating system; (iv) a proxy server receiving traffic from the client intended for a destination in the network; and (v) a secure sockets layer in which an instruction is sent to the server for performing link translation. Preferably, one or more security mechanisms is selected from a virtual private network client, a spy-ware scanner, a secure browser, an anti-virus scanner and a firewall. Preferably, the module is written at least in part in an extensible mark-up language.

According to the present invention, there is provided a module executable by a processor of a client computer undergoing data communication in a client server network with a server. The module is transmitted by the server to the client computer upon request for an application by a user of the remote client computer. The module includes a collector mechanism which collects client information on the client computer; and a selector mechanism which selects one or more security mechanisms based on the client information. Preferably, the client information is collected without prompting the user. Preferably, the security mechanisms available include multiple encryption mechanisms and the selector mechanism selects solely one of the encryption mechanisms. Preferably, the module further includes an enabling mechanism which enables the security mechanisms.

According to the present invention, there is provided a program storage device readable by a machine, tangibly embodying a program of instructions executable by the machine to perform a method for providing security to a server undergoing data communications with a remote client computer in a client/server network. The method includes requesting an application by a user of a remote client. In response to the request, the server transmits a module which runs on the remote client computer. When run, the module collects client information regarding the client computer and based on the collected client information selects one or more security mechanisms.

### BRIEF DESCRIPTION OF THE DRAWINGS

The invention is herein described, by way of example only, with reference to the accompanying drawings, wherein:

FIG. 1 is a drawing of a conventional network in which the present invention is implemented;

FIG. 2 is a simplified schematic drawing of a gateway computer in which an application of the present invention is installed;

FIG. 3 is a simplified flow drawing of a method, according to an embodiment of the present invention; and

FIG. 4 is an exemplary embodiment of a process performed by an executable module downloaded from the gateway computer for securing a client computer, according to an embodiment of the present invention.

### DESCRIPTION OF THE PREFERRED EMBODIMENTS

The present invention is of a system and method of for securing remote clients over a public network.

The principles and operation of a system and method of secure remote clients selector, according to the present invention, may be better understood with reference to the drawings and the accompanying description.

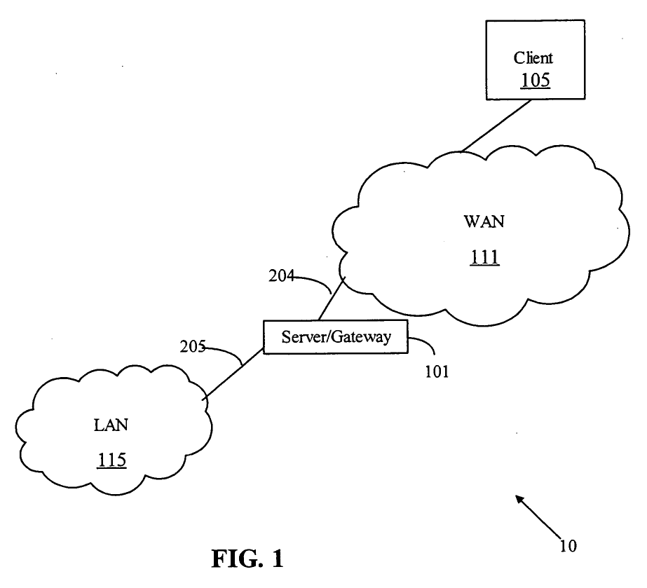

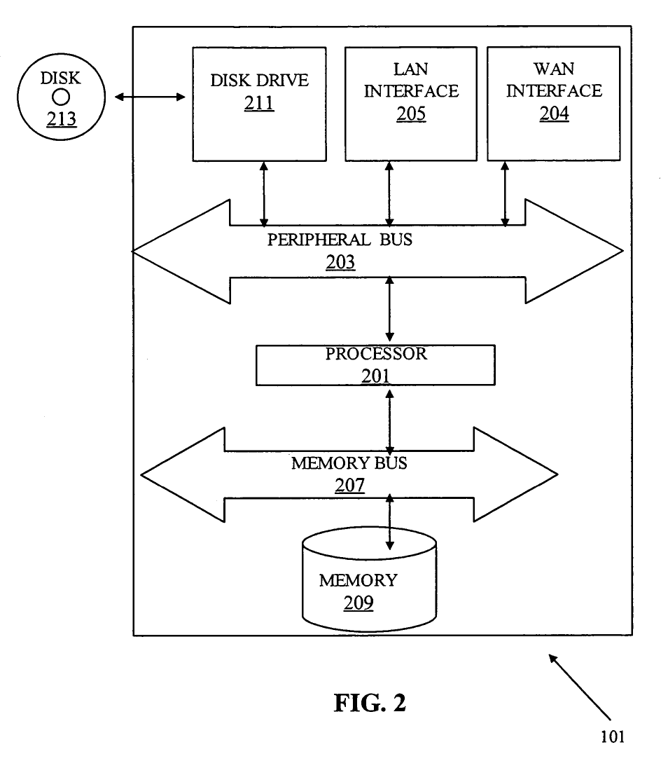

Reference is made to FIG. 1 which schematically illustrates a client/server network 10 in which an embodiment of the present invention is implemented. Typically, a client 105 of a local area network (LAN) 115 is attached to LAN 115 via gateway 101 and a wide area network (WAN) 111. Reference is now also made to FIG. 2 which illustrates gateway 101. Gateway 101, includes a processor 201, a storage mechanism including a memory bus 207 to store information in memory 209 and a WAN interface 204 and LAN interface 205, each operatively connected to processor 201 with a peripheral bus 203. Gateway 101 further includes a data input mechanism 211, e.g. disk drive from a program storage device 213, e.g. optical disk. Data input mechanism 211 is operatively connected to processor 201 with a peripheral bus 203.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, consider Sam an employee of ABC Sales corporation who is on vacation in Hawaii. Sam received a message at his hotel to download and respond to an electronic mail message from an important customer. Expecting to take a “real” vacation, he left his portable computer at home. Without a choice, Sam located an Internet cafe and found an unused computer, client computer 105. In order to attach to, for instance, the ABC electronic mail server, ABC sales corporation supports for instance only one or more virtual private networks for remote access but doesn't support any other browser based electronic mail access. Somewhat concerned that he will not be able to access his electronic mail because he doesn't know how to install the VPN client, Sam turns on computer 105, locates a Web browser, for instance, Mozilla Firefox and navigates to a portal of ABC sales corporation.

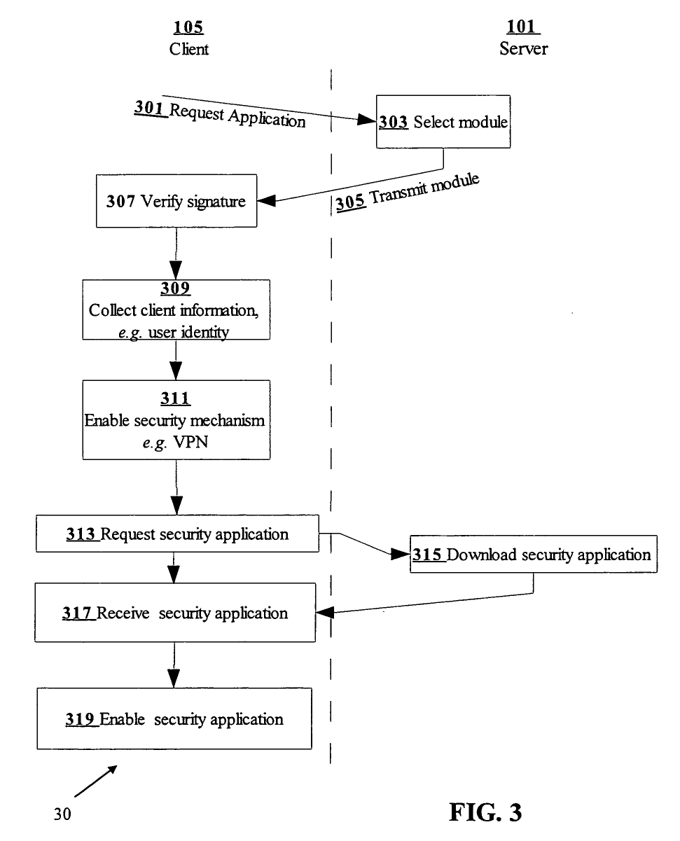

Referring now to the drawings, FIG. 3 illustrates a method 30 according to an embodiment of the present invention which allows, for instance, Sam access to the electronic mail application on for instance server/gateway 101. Using a portal on the Web browser, Sam logs in and requests (step 301) an application, e.g. Microsoft Outlook Web Application (OWA)™. Sam's login and request reaches server/gateway 101. Typically, the request includes information e.g. browser type and an executable module is selected (step 303 ) based on, for instance, the browser type and/or browser version. The browser on client 105 typically sends in the header of its HTTP request an identifier of the browser. Based on this identification, gateway 101 transmits (step 305) an appropriate executable module either in Java or ActiveX. Alternatively, gateway 101 sends a generic module suitable for one or more browsers.

In any case, the executable module is transmitted to client 105. Preferably, a signature is verified (step 307) prior to running the executable module. On executing, the module collects (step 309) client information, e.g. user identity information, on the user machine. Relevant client information includes operating system of remote client 105 and client applications installed on remote client 105 such as available browsers. The executable module typically determines the privileges of the user Sam who is operating remote client 105 and optionally his personal preferences. The executable module may gather further information by performing connectivity tests between remote client computer 105 and server 101. Preferably, the executable module checks for conflicting applications, e.g. firewall from a different vendor that is incompatible for instance with one or more of the VPN options. After collecting client information (step 309), the executable module enables (step 311) one or more security mechanisms. Possible security mechanisms include a VPN client, a spy-ware scanner, a virus scanner, a secure browser and/or a firewall. For instance, the executable module, based on a policy determined by the information systems department at ABC sales corporation, allows a connection between client 105 and server 101 only after a scan for viruses and spy-ware related Trojan worms. If appropriate anti-virus and anti-spy-ware applications are previously installed on remote client computer 105, then the applications are enabled, i.e. run. (step 311). Otherwise, the executable module requests (step 311) a download of an appropriate security application, to perform the required anti-virus and/or anti-spy-ware scan. The security application is downloaded (step 315 ) from server 101 to client computer 105 and is received (step 317 ) by client computer 105. The security application is enabled or run (step 319) on client computer 105 by the executable module. Preferably, download (step 315) is performed in a secure fashion, such as using encryption e.g. VPN and/or with the use of a digital signature. Throughout process 30, Sam is passive and does not need any special advance know-how to set up the required security mechanism, e.g. VPN client application, and preferably Sam is not required to supply any information for selecting the appropriate security mechanisms.

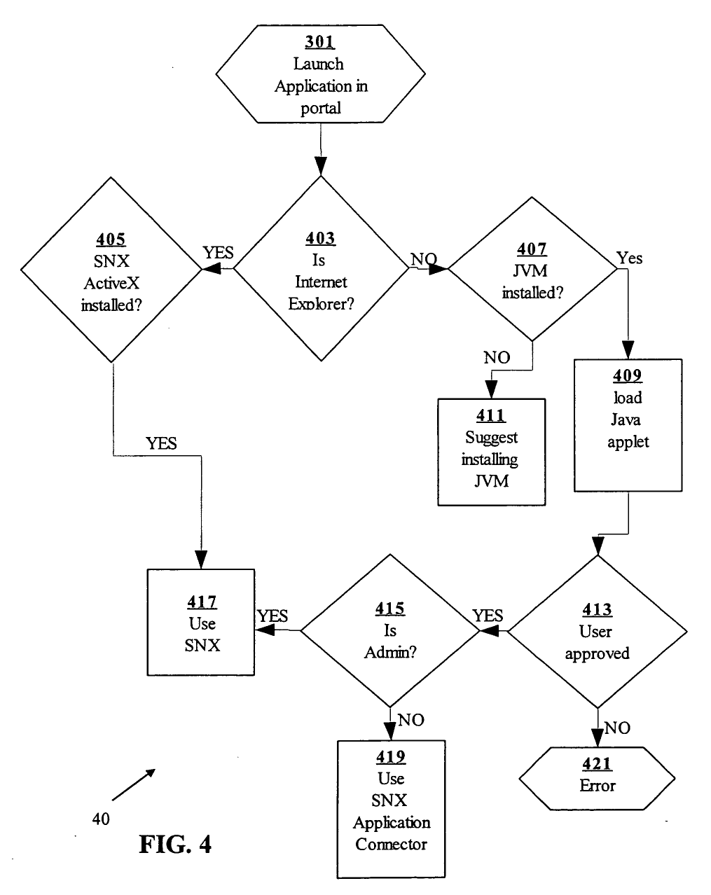

Another exemplary embodiment is shown in flow diagram 40 of FIG. 4, in which the executable module selects a VPN client application from two choices SSL network extender (SNX) and SNX application connector (both products of Check Point). The user of client 105, launches (step 301), an application in a portal using a Web browser. The executable module collects client information (step 309) regarding the Web browser currently in use and optionally regarding other Web browsers installed. In decision box 403, the executable module verifies that Microsoft Internet Explorer™ is currently in use and then in decision box 405 verifies if an ActiveX module appropriate for running SSL network extender (SNX) has been previously installed. If installed, then executable module selects SNX to implement a VPN. Otherwise, if Internet Explorer is not installed (decision box 403) then the executable module verifies (decision box 407) if a Java virtual machine (JVM) is installed. If a Java virtual machine is not installed, then the executable module suggests (step 411 ) installing the JVM. Otherwise, if a JVM is installed (decision box 407) then the executable module loads (step 409) an appropriate Java applet. If approved by the user (decision box 413) then the executable module determines if the user has administrator privileges and if so (decision box 415) executable module selects SNX for implementing a VPN. Otherwise, if the user in not an administrator (decision box 415) then the executable module selects SNX application connector (step 419 ) for implementing a VPN. If user doesn't not approve (step 413) or during any other stage of process 40 than an error message is generated and process 40 ends.

While the invention has been described with respect to a limited number of embodiments, it will be appreciated that many variations, modifications and other applications of the invention may be made.

What is claimed is:

1. A method for securing a server undergoing data communications with a remote client computer in a client/server network, the method comprising the steps of:
(a) upon requesting by a user of the client computer an application from the network, transmitting by the server in response to said requesting a module which runs on the client computer; and
(b) selecting by said module at least one security mechanism which secures the data communications with the remote client computer, wherein said selecting is based on client information that is collected on the client computer.

2. The method, according to claim 1, wherein said client information is collected without prompting said user.

3. The method, according to claim 1, wherein said at least one security mechanisms includes a plurality of encryption mechanisms and said selecting selects solely one of said encryption mechanisms.

4. The method, according to claim 1, further comprising the step of:
(c) identifying said user by said module.

5. The method, according to claim 1, wherein said transmitting is performed securely using a mechanism selected from the group consisting of a digital signature of said module and a secure sockets layer.

6. The method, according to claim 1, wherein said module is selected by the server based on information received from the client computer.

7. The method, according to claim 1, wherein said module is written in a language selected from the group consisting of Java and ActiveX based on a browser running on the client computer.

8. The method, according to claim 1, wherein said selecting is further based on at least one criterion selected from the group of criteria consisting of: (i) client applications installed on the remote client computer, (ii) preferences of a user running the remote client computer, (iii) privileges of a user running the remote client computer and (iv) connectivity tests between the remote client computer and the server.

9. The method, according to claim 1, wherein said selecting is based on at least one client application installed on the client computer, wherein said at least one client application is selected from the group consisting of an operating system and a Web browser.

10. The method, according to claim 1, wherein said selecting is based on an identity of a user of the client computer.

11. The method, according to claim 1, wherein said selecting is based on operating system privileges of the user of the client computer.

12. The method, according to claim 1, wherein said selecting is based on a Web browser running on the client computer, wherein the Web browser is characterized by at least one property selected from the group consisting of browser type, and browser version number.

13. The method, according to claim 1, wherein said selecting is based on a signature of at least one application being used on the client computer.

14. The method, according to claim 1, wherein said client information indicates a conflict between an application running on the client computer and at least one security mechanism, and said selecting is performed to resolve said conflict.

15. The method, according to claim 1, further comprising the step of:
(c) enabling said at least one security mechanism on the client computer.

16. The method, according to claim 1, wherein said at least one security mechanism includes one virtual private network based on a secure sockets layer.

17. The method, according to claim 1, wherein said at least one security mechanism includes one virtual private network implementation selected from the group consisting of
(i) an emulation of a network interface on the client;
(ii) a modification of an existing network interface;
(iii) processing traffic passing between a network interface and an operating system;
(iv) a proxy server receiving traffic from the client intended for a destination in the network; and
(v) a secure sockets layer wherein an instruction is sent to the server for performing link translation.

18. The method, according to claim 1, wherein said at least one security mechanism is selected from the group consisting of a virtual private network client, a spy-ware scanner, a secure browser, an anti-virus scanner and a firewall.

19. The method, according to claim 1, wherein at least a portion of said module is written in extensible mark-up language (XML).

20. A module executable by a processor of a client computer undergoing data communication in a client server network with a server, the module transmitted by the server to the client computer, the module comprising:
(a) a collector mechanism which collects client information on the client computer; and
(b) a selector mechanism which selects at least one security mechanism based on said client information;
wherein the module is transmitted to the client computer upon request from a user of the client computer for an application from the server.

21. The module, according to claim 20, wherein said client information is collected without prompting the user.

22. The module, according to claim 20, wherein said at least one security mechanism includes a plurality of encryption mechanisms, wherein said selector mechanism selects solely one of said encryption mechanisms.

23. The module, according to claim 20, further comprising:
(c) an enabling mechanism which enables at least one said security mechanism.

24. A program storage device readable by a machine, tangibly embodying a program of instructions executable by the machine to perform a method for providing security to a server undergoing data communications with a remote client computer in a client/server network, the method comprising the steps of:
(a) upon requesting by a user of the client computer an application from the network, transmitting by the server in response to said requesting, a module to the client computer; and
(b) selecting by said module at least one security mechanism which secures the data communications with the remote client computer, wherein said selecting is based on client information that is collected on the client computer.
